(19) United States
(12) Patent Application Publication
(10) Pub. No.: US 2009/0030821 A1
(43) Pub. Date: Jan. 29, 2009

(54) DIVERSE BILLING RECTIFICATION SYSTEM AND METHOD

(75) Inventors: Anthony J. Stegman, Houston, TX (US); Charles Pennington, Humble, TX (US); Julia Sweny, Houston, TX (US); George Fortney, Spring, TX (US)

Correspondence Address: HAYNES AND BOONE, LLP;IP Section, 2323 Victory Avenue, Suite 700, Dallas, TX, 75219, US

(73) Assignee: BENEFIT RECOVERY SYSTEMS, LP, Houston, TX (US)

(21) Appl. No.: 11/828,127

(22) Filed: Jul. 25, 2007

(51) Int. Cl. G06F 19/00

(52) U.S. Cl. 705/34

(57) ABSTRACT

A system and method for increasing claim recovery efficiency wherein an input engine receives claim data and is operatively coupled to both a clearinghouse system and an accounts receivable management system, which systems cooperatively identify errors in the claim record and prevent erred claim records from progressing to a payor. The clearinghouse system provides supplementation of the claim data for each claim record with additional data useful in electronic invoicing, assembly of claims for electronic invoicing, and submittal of claims for payment electronically. The clearinghouse is interactively coupled with the accounts receivable management system, which establishes and maintains an activity record for recovery efforts of each claim record, records process progression of each claim, coordinates error correction action, and assembles final disposition of each claim

### BACKGROUND

1. Field of the Disclosure

The present disclosure relates generally to the field of billing systems, and more specifically to a system for processing medical billing records from one billing system, such as the Federal government's system that may encompass a wide range of Department of Defense (“DOD”) and Veteran's Affairs (“VA”) facilities, into another distinct billing system.

2. Description of the Related Art

The complexity, variety, and fastidiousness of modern billing requirements, especially in the field of health care services and prescriptions, results in increased opportunities for errors. The errors in turn cause delays in payment or denial of payment for the goods or services. One example of complexity is the system of preexisting codes for standard patient treatment, referred to as CPT codes. The federal government requires coding of medical care goods and services for Medicare reimbursement, and the American Medical Association defines the codes. As part of a comprehensive system, CPT codes set forth a five digit code to identify a particular type of procedure in each of five main procedure rubrics: medicine; anesthesia; surgery; radiology; and pathology. CPT codes have been adopted by many insurance companies. Each code typically covers a category of specific medicinal procedures, as well as other ancillary information, such as the location of such procedure (e.g., emergency room, outpatient office visit etc.) and the duration of such visit. Such information is generally requested by the payor in order to properly analyze whether reimbursement of claims for patient services for payment by the provider is warranted.

CPT codes are cumbersome and expansive, and often cause confusion with practitioners. For example, in cases where certain specialties perform procedures that cross many sub-specialties, the procedures may technically fall under more than one CPT code. The practitioner's ability to get an invoice timely paid will depend on the ability to select the CPT code that not only covers the full scope of the procedures and goods, but that are deemed to be appropriate by the insurance carrier.

Another factor that adds complexity to modern claim payment systems is the number of diverse electronic invoicing systems that exist. Since each potential payor may have their own system for assessing the suitability and validity of a claim, proprietary systems result that ask for, and require, quantities of information about the patient, the source of insurance, the insured and the patient's relationship to the insured, the service or goods received, and the date of receipt, just to name a few examples. EBrors or discrepancies in any single piece of information may form the basis for a denial of payment, as explained in a document called an Explanation Of Benefits report (“EOB”) that typically accompanies either a payment or a denial of payment.

Therefore, in view of these challenges, it would be a valuable addition to the field of art to provide a system and process for rectiying and processing medical billing records from one billing system into another distinct billing system, while providing improved likelihood of recovery for each claim.

### SUMMARY OF THE DISCLOSURE

Elements included in this disclosure, and their relationships, may be viewed in a variety of ways. As such, the subject matter of the current disclosure may be described as a claim recovery system having an input engine configured to receive and copy a billing file having a claim record, and a clearinghouse system and an accounts receivable management system each configured to receive a copy of the billing file from the input engine, and to cooperatively identify errors in the claim record and prevent erred claim records from progressing to a payor.

In a first alternative, the subject matter of the current disclosure may be described as a claim recovery system having an input engine configured to receive and copy a billing file having a claim record and to receive corrected claim records, a clearinghouse system configured to receive a first copy of the billing file from the input engine, the clearinghouse system may further comprise a front-end processing engine configured to supplement claim data for each claim record with additional data useful in electronic invoicing, an error identification engine configured to identify errors in the claim record and to provide an activity report to the accounts receivable management system, an invoice assembly engine configured to assemble claim records for electronic invoicing, and an invoice submission engine configured to submit claim records electronically to payors for payment, and an accounts receivable management system configured to receive a second copy of the billing file from the input engine, and to cooperatively, with the clearinghouse system, identify errors in the claim record and prevent erred claim records from progressing to payors, and to receive payment information regarding the claim record from payors, the accounts receivable management system further comprising a claim activity record engine configured to establish and maintain an activity record for recovery efforts of each claim record, and to receive the activity report from any of the claim activity record engine, a correction engine, the front-end processing engine, the error identification engine, the invoice assembly engine, and the invoice submission engine, a claim flagging engine configured to record process progression of each claim record, the correction engine configured to perform correction action on erred claims, and a final disposition engine configured to assemble a final disposition of each claim record.

In a second alternative, the subject matter of the current disclosure may be described as a method for increasing claim recovery efficiency, having the steps of conducting intake-processing on a billing file that has a claim record, copying and distributing the billing file to both a clearinghouse system and an accounts receivable management system, and processing the billing file concurrently in both the clearinghouse system and the accounts receivable management system to cooperatively identify errors in the claim record and prevent erred claim records from progressing to a payor.

In a third alternative, the subject matter of the current disclosure may be described as a method for increasing claim recovery efficiency, having the steps of conducting intake-processing on a billing file having a claim record, copying and distributing the billing file to both a clearinghouse system and an accounts receivable management system, establishing and maintaining an activity record for each claim in the billing file, documenting claim activity in the activity record in order to compile a record of activity taken to recover the claim, conducting front-end processing on the billing file to supplement data for each claim record with additional data useful in electronic invoicing, identifying errors in the billing file in order to direct an erred claim record for correction action, taking error correction action on the erred claim record, and assembling an invoice of the claim record not identified to have errors.

### BRIEF DESCRIPTION OF THE DRAWINGS

FIG. 1 is a schematic diagram of payment system including an exemplary claim recovery system according to the present disclosure.

FIG. 2 is a schematic diagram of the components of an exemplary accounts receivable management system, as in FIG. 1.

FIG. 3 is a schematic diagram of the components of an exemplary clearinghouse system, as in FIG. 1.

FIG. 4 is a flow diagram of an exemplary process for processing claims for recovery using an exemplary claim recovery system of the current disclosure.

### DETAILED DESCRIPTION

For the purposes of promoting an understanding of the principles of the invention, reference will now be made to the embodiments, or examples, illustrated in the drawings and specific language will be used to describe the same. It will nevertheless be understood that no limitation of the scope of the invention is thereby intended by the specific examples. Any alterations and further modifications in the described embodiments, and any further applications of the principles of the invention as described herein are contemplated as would normally occur to one skilled in the art to which the invention relates.

This disclosure refers to “engines,” which are generally understood in the context of a system to mean an agent, instrument, or combination of either, or both, agents and instruments that may be associated to serve a purpose or accomplish a task. Agents and instruments may include individuals with particular skills or capabilities, computers, components of computers, programmable logic devices, microprocessors, software, software routines, communication equipment, networks, network services, and other elements and their equivalents that exist, are being developed and may be developed, which contribute to the purpose or task to be accomplished.

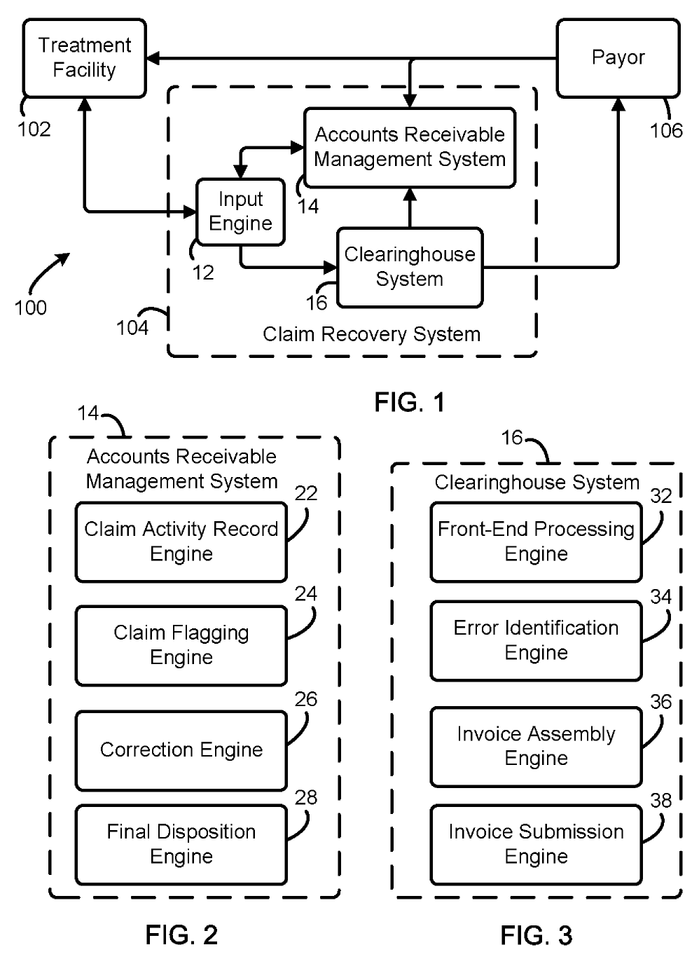

Referring to FIG. 1, an exemplary payment system 100 includes a treatment facility 102, a claim recovery system 104, having an input engine 12, an account receivable management system 14 and a clearinghouse system 16, and a payor 106. The treatment facility 102 and the payor 106 are not part of the claim recovery system 104, but instead are independent systems with which the claim recovery system 104 interacts. Additionally, either or both the treatment facility 102 and the payor 106, as referred herein, may include agents operating on behalf of a treatment facility 102 or payor 106.

The treatment facility 102 provides goods and services to individuals who may be entitled to have the charges for the goods and services paid by a third party payor, such as an insurance company. In this example, the individual receiving goods and services may be referred to as a “patient.” The treatment facility 102 compiles data regarding the goods and services provided, along with the justification for providing such goods and services, as well as information regarding the patient's right to have the third party payor 106 pay the treatment facility 102 for the goods and services received. The data, also known as claim data, represents the treatment facility's 102 claims that the payor 106 owes the treatment facility 102 for the goods and services provided to the patient. In the field, the delivery of a single good, a single service, or a single, recognized collection of combined goods and services generally creates a single claim. The claim may be represented by a single CPT code or other designation acceptable to the payor.

Depending on the relationship between the treatment facility 102 and the payor 106, the treatment facility 102 may submit a compilation of claims to a payor 106 in a single data file, referred to as a billing file. The data contained in the billing file delineates individual claims, keeping all the pertinent data for a particular claim in respective individual records, referred to as claim records. In this disclosure the records or claim records may be referred to, either individually or collectively, as merely claims. Again, depending on the relationship between the treatment facility 102 and the payor 106, the treatment facility 102 may submit claims to the payor 106 through a claim recovery system 104, referred to herein as a “CRS.”

The exemplary CRS 104 receives the data file from the treatment facility 102 through input engine 12. The input engine 12 may control the flow of data into the CRS 104 to ensure the data is coming from authorized sources. The input engine 12 may perform an initial review to check for data integrity and obvious errors. The input engine 12 may also have the capacity to ensure the data is in appropriate format and to change the formatting of the data. The input engine 12 may have the capacity to communicate to treatment facility 102 the status of the file transfer and any anomalies identified in the initial review of the data. The input engine 12 may then forward copies of the data file to either or both the accounts receivable management system 14 and the clearinghouse system 16. In the exemplary embodiment the input engine is a personal computer and a human operator, where the computer is configured to communicate electronically with both treatment facilities 102 and payors 106 via a secure network and the operator is knowledgeable in the area of billing processes, and computer communication and data transfer.

The exemplary CRS 104 employs a clearinghouse system 16 to process the data file to ensure the claim records are in a form most likely to be acceptable by the particular payor 106. The exemplary CRS 104 may concurrently process the data file with an accounts receivable management system 14 in order to manage the claim recovery process. By closely managing the claim recovery cooperatively with the accounts receivable management system 14 and the clearinghouse system 16, specialized recovery techniques may be employed to ident potential claim recovery problems. Varied, new and future recovery techniques may be employed to the CRS 104, as required by the problems that are identified. It is understood that various specialized recovery techniques exist, and that other specialized recovery techniques may exist that may be secret and proprietary. The techniques may vary, depending on the particular payor, and may be as simple as placing a phone call to an appropriate person at the appropriate time, using or avoiding particular goods or treatment CPT codes, or ensuring the timing of the claim submission is in accordance with the policies governing the particular treatment facility/payor relationship, as examples.

Referring to FIG. 2, the exemplary accounts receivable management system 14 may include a claim activity record engine 22, a claim flagging engine 24, a correction engine 26, and a final disposition engine 28. The claim activity record engine 22 establishes an activity record for each claim record, or verifies an activity record is already established for claims being re-processed, and documents all activity relating to each particular claim in the activity record. The activity record is an information storage place where information relating to a particular record may be maintained, and may be comprised of any of a variety of storage mediums. The claim activity record engine 22 makes the activity information readily available to a user of the CRS 104, so that the user of the CRS 104 may readily see the entire recovery process history of a particular claim. The claim activity record engine 22 establishes an activity record for each claim record in order to compile a record of activity taken to attain payment for the particular claim, which is to recover the particular claim.

In the exemplary embodiment, illustrated in FIG. 2, the claim flagging engine 24 may flag claim records to record and indicate the claim's position and progress in the process. Flagging may include a variety of techniques where information is associated with a claim record in order to identify the claim's position in the process, including addition of a field of data or merely a single bit of data. By attaching the information to a claim record the claim flagging engine 24 records the associated claim record's process progression. Typical positions in the process through which the claim record may progress that may be flagged include post-invoicing and post-claim payment. The flags provided by the claim flagging engine 24 permit a user of the CRS 104 to identify a grouping of all claims that are at a specific position of progression in the process and to identify trends or anomalies in the process progression of particular claims. Depending on the particular claim record's prior activity, claim flagging engine 24 routes the flagged claims to the correction engine 26 or the final disposition engine 28.

In the exemplary embodiment, illustrated in FIG. 2, the correction engine 26 may coordinate error correction by grouping the faulty claims by error type, which in conjunction with the requirements of the particular payor determines the correction efforts to be employed by a user of the CRS 104 to attempt to fix the fault. Correction efforts may include identiying omitted information, correcting data formats, correcting typographic errors, contacting the treatment facility for clarification or additional information, and contacting the patient for clarification and additional information, to name a few examples. Other types of correction efforts may be known, while others may be secret or proprietary, or are being or will be developed. The fault-fixing action is recorded by the claim activity record engine 22 and the fixed claim is grouped with other fixed claims to be sent back to the clearinghouse system for invoicing.

In the exemplary embodiment, illustrated in FIG. 2, the final disposition engine 28 may operate to assemble the final disposition information of each claim. The disposition information of each claim may be recorded in the respective activity report and the final disposition engine 28 may use this information to create a ledger that may list the payments and non-payments. The ledger may be referred to as a ledger report or a final disposition. The final disposition engine 28 may use this assembled ledger report, which rectifies actual payments received, as documented by the collective activity records of all the claims that have attained their final disposition, in order to compare to payor reports and EOB's. The status of a particular claim included in the final disposition may include full payment, partial payment, where a part of the claim value is written-off, or non-payment where the entire claim value is written-off. Alternatively, the final disposition engine 28 may receive a ledger report from the treatment facility 102, compiled from individual payor reports and EOB's received by the treatment facility 102. In that instance the final disposition engine 28 rectifies the treatment facility's 102 ledger report with the collective activity records of all the claims that have attained their final disposition, in order to inform the treatment facility of any errors, omissions, or anomalies. The treatment facility 102 may then determine the final disposition of each claim, which may include full payment partial payment, where a part of the claim value is written-off, or non-payment where the entire claim value is written-off.

Referring now to FIG. 3, the exemplary clearinghouse system 16 may include a front-end processing engine 32, an error identification engine 34, an invoice assembly engine 36, and an invoice submission engine 38. The front-end processing engine 32 accomplishes front-end processing, which manipulates the billing file in order to make it suitable for electronic processing by a payor. Front-end processing may include supplementing each claim data record with additional data required for electronic invoicing by a particular payment systems. The supplemental data may include either or both standardized codes and codes unique to a particular payor.

In the exemplary embodiment illustrated in FIG. 3, error identification engine 34 may operate to identify errors, which may be claims that are critically flawed or possess data that is detectably incorrect The claims having errors, also referred to as erred claims or faulty claims, are identified for review and correction. Flaws and detectably incorrect data may overlap, and may include bits of data that are out of sequence or dropped, or data in one field that does not coincide with data in another field, such as a listed zip code not being in agreement with a listed city and state. In the exemplary embodiment, invoice assembly engine 36 operates to assemble claims cleared by the error identification engine 34 into electronic invoices acceptable to the respective payor. Varying electronic invoicing systems may have differing requirements that permit the invoice to be received and processed for payment electronically by a payor. The exemplary invoice submission engine 38 operates to communicate with the respective payors in order to transmit claims identified as the responsibility of a particular payor to that particular payor. Various forms of communication may be used, including transmission methods currently known and those that may be developed.

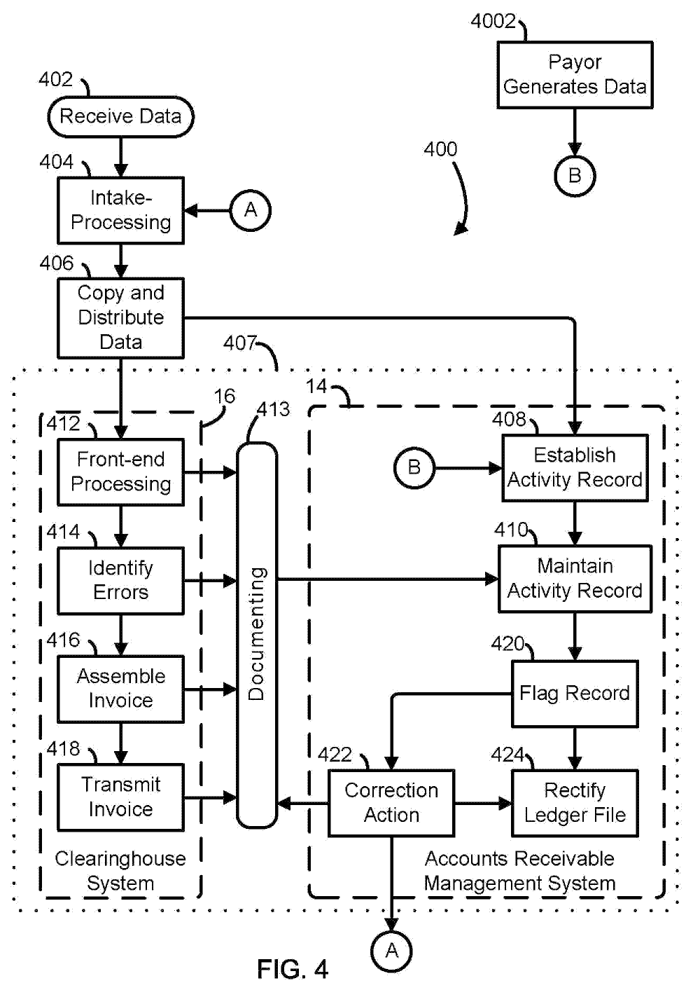

Referring now to FIG. 4, in an exemplary embodiment of a process 400 that employs the exemplary CRS 104, the process may start by receiving data, at 402, which data may contain a compilation of claims from a treatment facility 102. The treatment facility 102 interacts with and provides input to the process 400, but is not generally a part of the exemplary process 400. The data may include claims that identify multiple payors 106. Then at 404, the input engine 12 operates to perform intake-processing on the data, which actions may include acknowledging receipt, and scrubbing the data for proper form, errors and omissions. Then, in 406, the CRS 104 copies and distributes copies of the scrubbed data to both the account receivable management system 14 and the clearinghouse system 16, for respective, concurrent processing, in 407. In 407, the account receivable management system 14 and the clearinghouse system 16 operate concurrently, as necessary, in order to cooperatively identify and correct errors in the claim records thereby making it possible to avoid delays caused by sending erred claims to a payor.

In 408, the claim activity record engine 22, of the accounts receivable management system 14, ensures a record for each claim is established, so the activity of the claim recovery process may be thoroughly documented. Then at 410, the claim activity record engine 22 periodically receives and maintains activity reports from various other parts of the CRS 104.

In the clearinghouse system 16, the front-end processing engine 32, at 412, operates to perform front-end processing. Front-end processing may include activity to supplement the claim data records with additional data required by the particular electronic payment system identified in the claim. The front-end processing engine 32 provides documentation of a copy of the supplemented data to the claim activity record engine 22, at 413. Then at 414, the error identification engine 34 identifies claims with flaws, documenting information in the form of activity reports on the flawed claims, at 413, to be maintained by the claim activity record engine 22, at 410. Claims without detectable flaws are routed to the invoice assembly engine 36, in order to be assembled into electronic invoices acceptable to the respective payor, at 416. Claims without detectable flaws include claims that were previously flawed, but which have been corrected by the correction engine 26. Also at 416, copies of the assembled invoices are sent to the invoice submission engine 38, as well as being documented in an activity report, at 413, to be maintained by the claim activity record engine 22, at 410. At 418, the assembled electronic invoice records are then transmitted to the respective payor by the invoice submission engine 38, which also documents such transmission, at 413, as an activity report to be maintained by the claim activity record engine 22, at 410.

Activity reports are maintained within the claim activity record engine 22, at 410, and cause the claim flagging engine 24 to flag the claim records, at 420, in order to indicate the existence of flaws in a particular claim, as well as to record each claim's progress through the process steps. Claim records that are flagged as faulty are routed to the correction engine 26 for correction actions, at 422. Correction actions result in the corrected claims being rerouted to the input engine for a repeat of intake-processing on the data, at 404, as well as being documented, at 413, as in an activity report, to be maintained by the claim activity record engine 22, at 410. Claims that are uncorrectable are flagged as final and progress to the final disposition engine 28, in order to be rectified with the ledger file, at 424. Rectifying the ledger file, at 424, results in information on which claims were paid in full, partially paid and partially written-off, and written-off in full.

Once invoices are transmitted to a payor 106, at 418, a payor 106 may generate payor data, at 4002. The payor's action interacts with and provides input to the process 400, but is not generally a part of the exemplary process 400. The payor 106 may transmit the payor data to the treatment facility 102, which in turn will transmit the payor data to the input engine 12, at 402. Payor data may include payment or non-payment information, including an EOB. The input engine 12 receives, verifies and acknowledges the receipt of the payor data, at 402. Process 400 processes this payor data regarding claims slightly differently, because this payor data may not be in the form of a claim record that the clearinghouse system 16 typically processes. The input engine 12 distributes the payor data to the account receivable management system 14, for processing. In 408, the claim activity record engine 22 ensures a record for each claim referenced by the payor data exists, creating the record if it does not exit. Then at 410, the claim activity record engine 22 records and maintains the receipt and content of the payor data for each claim. Then at 420, the claim flagging engine 24 flags the claim record as final, if the payor data shows the claim is paid in full. Otherwise, the claim is routed to the correction engine 26 for review and correction action, at 422, designed to obtain optimum payment of the claim. A claim record where the EOB is accurate, and the correction engine 26 determines that the claim recovery can not be improved, is flagged as final by the correction engine 26 and routed to the final disposition engine 28 to be included in rectifying the ledger file at 424.

Alternatively, the payor 106 may transmit the payor data directly to the claim activity record engine 22, at 408, where the claim activity record engine 22 ensures an activity record for each claim referenced by the payor data exists, creating the record if it does not exit. Then at 410, the claim activity record engine 22 records and maintains the receipt and content of the payor data for each claim. Then at 420, the claim flagging engine 24 flags the claim record as final, if the payor data shows the claim is paid in full. Otherwise, the claim is routed to the correction engine 26 for review and correction action, at 422, designed to obtain optimum payment of the claim. A claim record where the EOB is accurate, and the correction engine 26 determines that the claim recovery can not be improved, is flagged as final by the correction engine 26 and routed to the final disposition engine 28 to be included in rectiying the ledger file at 424.

A claim record where the payor data is determined to be inaccurate by the correction engine 26, is corrected by correction actions, at 422. The correction actions are recorded and maintained as an activity report at 410, and the corrected record is recycled to the input engine 12 for repeat intake-processing on the data, at 404, as claim data, in a similar data structure to that sent by the treatment facility 102.

Then, in 406, the corrected claim is then copied and distributed to both the account receivable management system 14 and the clearinghouse system 16, for respective processing, similar to the description above. In the clearinghouse system 16, the front-end processing engine 32, at 412, operates to perform front-end processing. Front-end processing, at 412, may include activity to supplement the claim data records with additional data required by the particular electronic payment system identified in the claim. Then at 414, the error identification engine 34 may identify new potential errors in the claim data, routing information in the form of activity reports on the flawed claims to be maintained by the claim activity record engine 22, at 410. Since the recycled claim was previously reviewed, the occurrence of flawed claims should be low. Claims that do not have newly identified errors have their action within the clearinghouse system 16 suspended in the error identification engine 34. In incidences where a recycled claim is identified to have a new potential error, the claim is flagged as flawed by the claim flagging engine 24, at 420, and progresses to the correction engine 26 for correction actions, at 422. After correction actions, at 422, the claim is sent back to the input engine 12 for repeat intake-processing on the data, at 404, with the errors corrected by the correction engine 26. Once completely corrected, a claim with will proceed through the process 400 to invoice assembly, at 416, and invoice transmission, at 418. A recycled claim that is not flawed will conclude action in the clearinghouse system 16 in the error identification engine 34, and in the accounts receivable management system 14 in the final disposition engine 28, in ledger file rectification, at 424.

In at least one instance the DOD established a file structure for use by treatment facilities 102 under DOD control, and data files having such structure may be received by the input engine 12, at 402. The file structure that may be received by the input engine 12, at 402, may include of a series of fields, into which treatment facility data may be arrange. Each field of the file structure may have a name the may provide some idea of the information the data of that particular field represents. An exemplary DOD file structure may include the following fields:

001: CONTROL_NUMBER=Accounts.Control_number
002: FILLER1=
003: FILLER2=
004: ENTRY_USER=
005: ENTRY_DATE=
006: ENTRY_SOURCE=
007: ENTRY_TYPE=
008: ENCOUNTER_DISPOSITION_CODE=
009: ENCOUNTER_DISPOSITION_DESC=
010: BILL_TYPE=
011: BILL_TYPE_DESCRIPTION=
012: BILL_COMPONENT_TYPE=
013: BILL_RANK=AcctSup.BILL_RANK
014: FILLER3=
015: TOTAL_AMOUNT=Accounts.total_billed
016: INSURANCE_FORM_ID=
017: ENCOUNTER_DATE=Accounts.Admit_date
018: ENCOUNTER_LAST_DATE=
019: NDC_REVENUE_CODE=
020: PARENT_CONTROL_NUMBER=
021: CHCS_HOST_DMIS_ID=
022: LOCALITY_CODE=
023: TREATMENT_DMIS_ID=
024: TREATMENT_PARENT_DMIS_ID=
025: OFFICE_VISIT_CODE=
026: OFFICE_VISIT_DESCRIPTION=
027: OFFICE_VISIT_RATE=
028: AMBULANCE_TIME=
029: AMBULANCE_RATE=
030: PATIENT_INTERNAL_ENTRY_NUMBER=
031: PATIENT_ID=Accounts.PATIENT_ID
032: PATIENT_LAST_NAME=Accounts.Pat_L_Name
033: PATIENT_FIRST_NAME=Accounts.Pat_F_Name
034: PATIENT_MIDDLE_INITIAL=Accounts.Pat_MI
035: PATIENT_LAST_NAME_SUFFIX=AcctSup.PAT_LNAME_SUFFIX
036: DATE_OF_BIRTH=Accounts.PAT_DOB
037: GENDER=AcctSup.GENDER
038: MARITAL_STATUS_CODE=AcctSup.MARITAL_STATUS_CD
039: PATIENT_CATEGORY=AcctSup.PATIENT_CATEGORY
040: DOD_REPORTING_CATEGORY=AcctSup.DOD_REPORTING_CATEGORY
041: SSN=Accounts.PAT_SSN
042: PATIENT_HOME_PHONE=Accounts.PAT_HOME_PHONE
043: PATIENT_HOME_PHONE_EXTENSION=
044: PATIENT_ADDRESS1=Accounts.PAT_ADDR1
045: PATIENT_ADDRESS2=Accounts.PAT_ADDR2
046: PATIENT_CITY=Accounts.PAT_City
047: PATIENT_STATE=Accounts.PAT_STATE
048: PATIENT_ZIP=Accounts.PAT_ZIP
049: PATIENT_COUNTRY_CODE=
050: PATIENT_FMP=
051: SPONSOR_SSN=Accounts.RP_SSN
052: INSURED_FMP=
053: PATIENT_INSURED_RELATION_CODE=AcctSup.PAT_INS_RELATION_CD
054: HCP_INTERNAL_ENTRY_NUMBER=
055: HCP_NUMBER=AcctSup.HCP_NO
056: HCP_ID=AcctSup.HCP_ID
057: HCP_ID_TYPE=
058: HCP_QUALIFIER_CODE=
059: HCP_LAST_NAME=AcctSup.HCP_LNAME
060: HCP_FIRST_NAME=AcctSup.HCP_FNAME
061: HCP_CMAC_CLASS=
062: HCP_SPECIALTY_CODE=
063: HCP_2_INTERNAL_ENTRY_NUMBER=
064: HCP_2_NUMBER=
065: HCP_2_ID=
066: HCP_2_ID_TYPE=
067: HCP_2_QUALIFIER_CODE=
068: HCP_2_LAST_NAME=
069: HCP_2_FIRST_NAME=
070: HCP_2_CMAC_CLASS=
071: HCP_2_SPECIALTY_CODE=
072: HCP_2_ROLE=
073: HCP_3_INTERNAL_ENTRY_NUMBER=
074: HCP_3_NUMBER=
075: HCP_3_ID=
076: HCP_3_ID_TYPE=
077: HCP_3_QUALIFIER_CODE=
078: HCP_3_LAST_NAME=
079: HCP_3_FIRST_NAME=
080: HCP_3_CMAC_CLASS=
081: HCP_3_SPECIALTY_CODE=
082: HCP_3_ROLE=
083: MEPRS_CODE=
084: MEPRS_DESCRIPTION=
085: SITE_ID=
086: REPORTING_CODE=
087: ORGANIZATION_CODE=
088: BCBS_NUMBER=
089: POLICY_HOLDER_ID=AcctSup.PHOLDER_ID
090: POLICY_HOLDER_SSN=Accounts.RP_SSN
091: POLICY_HOLDER_LAST_NAME=Accounts.RP_L_NAME
092: POLICY_HOLDER_FIRST_NAME=Accounts.RP_F_NAME
093: POLICY_HOLDER_MIDDLE_INITIAL=Accounts.RP_MI
094: POLICY_HOLDER_LAST_NAME_SUFFIX=
095: POLICY_HOLDER_GENDER=
096: POLICY_HOLDER_DATE_OF_BIRTH=
097: POLICY_HOLDER_HOME_PHONE=Accounts.RP_HOME_PHONE
098: POLICY_HOLDER_HOME_PHONE_EXT=
099: POLICY_HOLDER_ADDRESS1=Accounts.RP_ADDR1
100: POLICY_HOLDER_ADDRESS2=Accounts.RP_ADDR2
101: POLICY_HOLDER_CITY=Accounts.RP_CITY
102: POLICY_HOLDER_STATE=Accounts.RP_STATE
103: POLICY_HOLDER_ZIP=Accounts.RP_ZIP
104: POLICY_HOLDER_COUNTRY=
105: EMPLOYER_ID=
106: EMPLOYER_NAME=Accounts.EMP_NAME
107: EMPLOYER_ADDRESS1=Accounts.emp_addr1
108: EMPLOYER_ADDRESS2=Accounts.emp_addr2
109: EMPLOYER_CITY=Accounts.emp_city
110: EMPLOYER_STATE=Accounts.emp_state
111: EMPLOYER_ZIP=Accounts.emp_zip
112: EMPLOYER_COUNTRY=
113: STANDARD_INSURANCE_COMPANY_ID=
114: INSURANCE_COMPANY_NAME=Accounts.PAYORA_FRM_CLI
115: INSURANCE_COMPANY_ADDRESS1=
116: INSURANCE_COMPANY_ADDRESS2=
117: INSURANCE_COMPANY_CITY=
118: INSURANCE_COMPANY_STATE=
119: INSURANCE_COMPANY_ZIP=
120: FILLER4=
121: INSURANCE_TYPE=
122: POLICY_GROUP_NUMBER=AcctSup.POLICY_GROUP_NO
123: POLICY_GROUP_NAME=AcctSup.POLICY_GROUP_NAME
124: POLICY_NUMBER=Accounts.Policy_Number
125: POLICY_ID=AcctSup.POLICY_ID
126: DRUG_COVERAGE_NUMBER=AcctSup.DRUG_COV_NO
127: INSURED_THROUGH_EMPLOYER=
128: REMARKS=
129: BATCH_PRINT_NUMBER=
130: OCCURRENCE_CODE=
131: OCCURRENCE_DATE=
132: OCCURRENCE_CODE_2=
133: OCCURRENCE_DATE_2=
134: OCCURRENCE_CODE_3=
135: OCCURRENCE_DATE_3=
136: OCCURRENCE_CODE_4=
137: OCCURRENCE_DATE_4=
138: SPAN_START_DATE=
139: SPAN_END_DATE=
140: PRE_CERTIFICATION=
141: ELECTRONIC_TRANSMISSION=
142: ELECTRONIC_UB92_PAYER_ID=
143: ELECTRONIC_HCFA_PAYER_ID=
144: ELECTRONIC_UCF_PAYER_ID=
145: ELECTRONIC_INSURANCE_NAME=
146: ELECTRONIC_BATCH_NUMBER=
147: ELECTRONIC_BATCH_DATE=
148: HYPERBARIC_TIME=
149: HYPERBARIC_RATE=
150: RADIOGRAPH=
151: RADIOGRAPH_NUMBER=
152: PROSTHESIS=
153: PROSTHESIS_REASON=
154: PROSTHESIS_DATE=
155: ORTHODONTICS=
156: ORTHODONTICS_DATE=
157: ORTHODONTICS_MOS=
158: OBSERVE_RATE=
159: FILLER5=
160: MEDIGAP_AMOUNT=
161: CHIEF_COMPLAINT_CODE=
162: CHIEF_COMPLAINT_DESCRIPTION=
163: ENCOUNTER_AGE=AcctSup.ENCOUNTER_AGE
164: DEERS_ELIGIBILITY_FLAG=
165: HCDP_CODE=
166: THIRD_PARTY_LIAB_INDICATOR=
167: WORK_INJURY_DATE=
168: APPOINTMENT_INTERNAL_ENTRY_NO=
169: APPOINTMENT_MATCH_INDICATOR=
170: APPOINTMENT_STATUS_TYPE=
171: ENCOUNTER_CANCELLATION_DATE=
172: WORKLOAD_COUNT_FLAG=
173: REGISTER_NUMBER=
174: AMBULATORY_SURGERY_FLAG=
175: OBSERVATION_BEG_DATE=
176: OBSERVATION_END_DATE=
177: PATIENT_DISPOSITION_CODE=
178: ICD_9_DOWNLOAD_YEAR=AcctSup.ICD_9_DOWNLOAD_YEAR
179: CPT_4_DOWNLOAD_YEAR=
180: TOTAL_CPT_CODES_PER_ENCOUNTER=AcctSup.TOT_CPT_CODES_PER_ENC
181: ORDER_REQUEST_LOC_DMIS_ID=
182: LAB_ACCESSION_NUMBER=
183: RADIOLOGY_EXAM_NUMBER=
184: EXTERNAL_LAB_TYPE=
185: EXTERNAL_PERFORM_LOC_NAME=
186: EXTERNAL_PERFORM_LOC_ADDRESS1=
187: EXTERNAL_PERFORM_LOC_ADDRESS2=
188: EXTERNAL_PERFORM_LOC_CITY=
189: EXTERNAL_PERFORM_LOC_STATE=
190: EXTERNAL_PERFORM_LOC_ZIP=
191: EXTERNAL_PERFORM_LOC_COUNTRY=
192: EXTERNAL_PERFORM_LOC_PHONE=
193: RX_NUMBER=
194: FILL_NUMBER=
195: CLAIM_FREQUENCY_CODE=
196: PATIENT_STATUS_CODE=
197: EMPLOYMENT_STATUS_CODE=
198: CONDITION_CODE=AcctSup.CONDITION_CD
199: CONDITION_CODE2=
200: CONDITION_CODE3=
201: CONDITION_CODE4=
202: OCCURRENCE_SPAN_CODE=
203: VALUE_CODE=
204: VALUE_CODE_AMOUNT=
205: VALUE_CODE2=
206: VALUE_CODE_AMOUNT2=
207: VALUE_CODE3=
208: VALUE_CODE_AMOUNT3=
209: VALUE_CODE4=
210: VALUE_CODE_AMOUNT4=
211: OTHER_COVERAGE_CODE=
212: PERSON_CODE=
213: PRIOR_AUTHORIZATION_TYPE_CODE=
214: PARENT_ENCOUNTER_ID=
215: NCPDP_PHARM_ID=
216: FILE_NAME=
217: SITE_COMMUNICATE_NUMBER_QUAL1=
218: SITE_COMMUNICATE_NUMBER_QUAL2=
219: SITE_COMMUNICATE_NUMBER_QUAL3=
220: PATIENT_MEDICARE_COVERAGE=
221: CLAIM_FILING_CODE=
222: PATIENT_REF_ID_CODE_QUAL=
223: PATIENT_REF_ID_CODE_QUAL2=
224: PHOLDER_REF_ID_CODE_QUAL=
225: PHOLDER_REF_ID_CODE_QUAL2=
226: DOD_STANDARD_INSURANCE_COMP_ID=
227: HCP_ROLE=
228: HCP_PROVIDER_CODE=
229: HCP_ID_CODE_QUALIFIER=
230: HCP_ID_CODE_QUALIFIER2=
231: HCP_ID2=
232: HCP_TAXONOMY_CODE=
233: HCP_2_PROVIDER_CODE=
234: HCP_2_ID_CODE_QUALIFIER=
235: HCP_2_ID_CODE_QUALIFIER2=
236: HCP_2_ID2=
237: HCP_2_TAXONOMY_CODE=
238: HCP_3_PROVIDER_CODE=
239: HCP_3_ID_CODE_QUALIFIER=
240: HCP_3_ID_CODE_QUALIFIER2=
241: HCP_3_ID2=
242: HCP_3_TAXONOMY_CODE=
243: ACCIDENT_RELATED_CAUSE_CODE=
244: ACCIDENT_GEOGRAPHIC_LOC_CODE=
245: ACCIDENT_COUNTRY_CODE=
246: PREGNANCY_INDICATOR=
247: LAST_MENSTRUAL_PERIOD=
248: ESTIMATED_DATE_OF_BIRTH=
249: PRE_PROCEDURE_WEIGHT=
250: PRE_PROCEDURE_WEIGHT_QUAL=
251: POST_PROCEDURE_WEIGHT=
252: POST_PROCEDURE_WEIGHT_QUAL=
253: SIMILAR_ILLNESS_SYMPTOM_DATE1=
254: SIMILAR_ILLNESS_SYMPTOM_DATE2=
255: SIMILAR_ILLNESS_SYMPTOM_DATE3=
256: SIMILAR_ILLNESS_SYMPTOM_DATE4=
257: REFERRAL_NUMBER_IEN=
258: REFERRAL_DATE=
259: REFERENCE_ID_QUALIFIER=
260: REFERRING_HCP_IEN=AcctSup.REFERRING_HCP_IEN
261: REFERRING_HCP_NUMBER=AcctSup.REFERRING_HCP_NO
262: REFERRING_HCP_ID_CD_QUALIFIER=
263: REFERRING_HCP_ID=
264: REFERRING_HCP_ID_CD_QUALIFIER2=
265: REFERRING_HCP_ID2=
266: REFERRING_HCP_TAXONOMY_CODE=
267: REFERRING_HCP_LAST_NAME=AcctSup.REFERRING_HCP_LNAME
268: REFERRING_HCP_FIRST_NAME=AcctSup.REFERRING_HCP_FNAME
269: REFERRING_HCP_LAST_SEEN_DATE=
270: OTHER_PAYER_PRIOR_AUTHOR_NUM=
271: SERVICE_LINE_NOTE_REF_CODE=
272: SERVICE_LINE_NOTE_TEXT=
273: LAB_CLIA_NUMBER=
274: PURCHASED_SERV_PROV_ID_CD_QUAL=
275: PURCHASED_SERV_PROV_ID=
276: ACCIDENT_RELATED_CAUSE_CODE2=
277: ACCIDENT_RELATED_CAUSE_CODE3=
278: FILLER6=
279: FILLER7=
280: FILLER8=
281: DIAG_CODE=
282: DIAG_DESCRIPTION=
283: NDC_NUMBER=RxData.NDC_NUMBER
284: NDC_DESCRIPTION=RxData.NDC_DESCRIPTION
285: NDC_QUANTITY=RxData.NDC_QUANTITY
286: NDC_COST=RxData.NDC_COST
287: NDC_FILL_FEE=RxData.NDC_FILL_FEE
288: NDC_REVENUE_CODE=
289: NDC_STRENGTH=RxData.NDC_STRENGTH
290: NDC_DOSAGE_FORM=RxData.NDC_DOSAGE_FORM
291: RX_NUMBER=RxData.RX_NUMBER
292: RX_NUMBER_QUALIFIER_CODE=
293: FILL_NUMBER=RxData.FILL_NUMBER
294: REFILL_FLAG=RxData.REFILL_FLAG
295: DAYS_SUPPLY=RxData.DAYS_SUPPLY
296: DATE_WRITTEN=
297: ORDER_ID=
298: NCPDP_COMPOUND_CODE_FLAG=
299: NDC_NUMBER_STATUS_CODE=RxData.STATUS
300: ENCOUNTER_CANCELLATION_DATE=
301: RETURNED_TO_STOCK_DATE=
302: NDC_NUMBER_QUALIFIER_CODE=
303: DISPENSE_WRITTEN_CODE=
304: DUR_PPS_CODE=
305: BASIS_COST_CODE=
306: OTHER_PAYER_DATE=
307: OTHER_PAYER_ID=
308: OTHER_PAYER_ID_QUALIFIER_CODE=
309: OTHER_PAYER_REJECT_CODE=
310: USUAL_CUST_CHARGE=
311: BILL_NUMBER=
312: FILLER9=
313: ENCOUNTER_DISPOSITION_CODE=
314: NDC_TOTAL_AMOUNT=RxData.NDC_TOTAL_AMOUNT
315: PROCEDURE_TYPE=
316: PROCEDURE_CODE=
317: PROCEDURE_DESCRIPTION=
318: NDC_REVENUE_CODE=
319: PROCEDURE_RATE=
320: PROVIDER_CLASS_CODE=
321: DIAGNOSIS_CPT_LINK=
322: COUNT=
323: MODIFIER=
324: SERVICE_UNITS=
325: CPT_CODE_SEQUENCE=
326: ORDER_ID=
327: ORDER_DATE=
328: TECHNICAL_COMPONENT_DATE=
329: LAB_ACCESSION_NUMBER=
330: RADIOLOGY_EXAM_NUMBER=
331: PROCEDURE_CODE_INACTIVE_FLAG=
332: SYSTEM_OF_ORIGIN_FOR_RESULT=
333: QUANTITY=
334: RADIOLOGY_MODIFIER=
335: ENCOUNTER_CANCELLATION_DATE=
336: FORM_ID=
337: BILL_NUMBER=
338: PROCEDURE_COMPONENT_TYPE=
339: FILLER10=
340: ENCOUNTER_DISPOSITION_CODE=
341: CPT_CODE_ASSOCIATED_HCP=

In another conventional depiction, the file structure may be shown with the fields separated by vertical lines. Data, if present will be contained in the structure, delineated by vertical lines. Distinct claim records may be distinguished by one of an assortment of conventions, as chosen by the entity that establishes the file structure. Distinguishing conventions may include line breaks, semi-colons, or tabs, just to provide a couple examples. The file structure may start with the initial piece of data, followed by a vertical line. Subsequent data may be preceded and succeeded by vertical lines. A treatment facility 102 propagates the file structure with data relating to patient treatments, separating distinct claim records The file structure, when propagated with two exemplary entries of data separated by line breaks, each entry relating to a distinct patient treatment, may look like the following:

```
A07-1925||||||||||||1.00||208.70||2006-10-12 00:00:00||||||||||||||0109115822|SMITH| JANE||| 1934-
  09-28 00:00:00|F|U|F43|E|380117604|2105554889||5122 FORT WIXMAN ST||SAN
  ANTONIO|TX|78200|||380001140||02||010914582|
  061258018|||JONES|STANLEY||||||||||||||||||||||||||||45-03864|380991410|
  380991410|SMITH|JOHN|A|||||||5122 FORT WIXMAN ST|SAN ANTONIO|
  TX|78200|||FEDERAL|||||||34872|MHBP PHARMACY CLAIMS|PO BOX
  4804||LONDON|KY|40711|||455|FEHBP|380991410| 36670|||||||||||||||||||||||||||||||
  |||||||72|||||||||||||||||||||||||||||||||||||||||0.00||0.00||0.00||0.00|||||4503884||||||||||||||| ||||||||||||||||||||||||||||||
  |||||||||||||||||||||V68.1||00029321013|PAXIL 10 MG TABLET|90.00|
  2.23|8.00|250|TA||FA8377456|1|1.00||90.00|2006-10-12 00:00:00||||||03|||03
  |||||0.00||||208.70|||||||||||||||||||||||||||
  A07-2499||||||||||||1.00||120.20||2006-10-19 00:00:00||||||||||||||010950805|INGLES|
  PAIGE|E||1946-04-21 00:00:00|F|M|F43|E|633884884|210-555-6711||4803
  DURHAM||SAN ANTONIO|TX|78211|||633884884||01||010918135||||
  INGLES|SAM||||||||||||||||||||||||||||420009477|633884884|633884884|INGLES|
  PAIGE|E|||||||4803 DURHAM|SAN ANTONIO|TX|78211|||ERS OF TEXAS
  |||||||34694|MEDCO MILITARY CLAIMS|PO BOX 23720||LEXINGTON|
  KY|40599|||38000|HEALTH SELECT|ZGB633884884|35383||||||||||||||||||||||||||||
  ||||||||||60|||||||||||||||||||||||||||||||||||||||||0.00||0.00||0.00||0.00|||||4503884|||||||||||| ||||||||||||||||||||||||||||||
  ||||||||||||||||||||||||V68.1||00007414120|COREG 12.5 MG TABLET|
  60.00|1.87|8.00|250|TA||FG5006841|1|6.00||30.00|2006-10-19 00:00:00||||||
  03|||03|||||0.00||||120.20|||||||||||||||||||||||||||
```

The front-end processing engine 32 may perform front-end processing on the data within the file structure. As previously mentioned, front-end processing may include supplementing each claim data record with additional data required for electronic invoicing by a particular payment systems. The file structure of the first exemplary entry shown above, after completing a front-end processing, at 412, by the clearinghouse system 16, may look like the following:

```
A07-1925|1|2|CAPSTIN|2006-11-07 00:00:00|CHCS|INSERT|P01|READY TO
  PRINT|2|PHARM|2|1|3|288.70|1|2006-10-12 00:00:00|2006-12-04 00:00:00|
  250||0009||0009|0009||||||154189|0109115822|SMITH|JANE|||1934-09-28
  00:00:00|F|U|F43|E|380117604|2105554889||5122 FORT WIXMAN ST|| SAN
  ANTONIO|TX|78200||30|380001140|30|02|6695|010914582|
  061258018|||JONES|STANLEY|01||||||||||||||||||||||FCCA|EXTERNAL SERVICES-
  RADIOLOGY| A|E|O|45-03864| 380991410|380991410|SMITH| JOHN|A||F|1943-09-
  02 00:00:00||||5122 FORT WIXMAN ST|SAN
  ANTONIO|TX|78200|||FEDERAL|||||||34872|MHBP PHARMACY CLAIMS|PO BOX
  4804||LONDON|KY|40711|4|GP|455|FEHBP|380991410|
  36670||N||||||||||||||N|UB92|HCFA||SYSTEM|||||N||N|||N||||5||||72||||||||||||||||||0009||||||||||||||1||
  |||||||0.00||0.00||0.00||0.00|||||4503884|TPOCS_0009_0009_PHR_200612070100|||||09|||||
  BCBAZ0001||||||208D00000X||||||||||||||||||||||||||||||||||||||||||||||6|7|8|
  V68.1||00029321013|PAXIL 10 MG TABLET|90.00|2.23|8.00|250|TA||
  FA8377456|1|1||90|2006-10-12 07:24:00|060607-01201|N|A|||03|||03|||||0.00||
  9|P01|208.70||||250|||||||||||||||||| |||10|P01|
```

In the example above, the initial pieces of data within the first field were provided by the treatment facility 102. According to the file structure, the initial pieces of data, “A07-1925,” is a control number. The first field, as with subsequent fields, is followed by a vertical line. The next eleven fields did not include data from the treatment facility 102, so the vertical lines follow one after another. In the thirteenth field, however, the treatment facility 102 provided a bill rank of “1.00.” Front-end processing filled the second through twelfth fields with data designated by the file structure, and corrected the format of the bill rank data from “1.00” to “1” in the thirteenth field. Front-end processing similarly supplements the remainder of the fields of the data record with additional data required for electronic invoicing by the particular payment system.

Although only a few exemplary embodiments have been described in detail above, those skilled in the art will readily appreciate that many modifications are possible in the exemplary embodiments without materially departing from the novel teachings and advantages of this disclosure. For example, any element described in one embodiment may be integratable into any of the other embodiments, either individually or in varied combination. Additionally, any element or combination of elements may be substituted by an equivalent element or combination of elements. Accordingly, all such adjustments and alternatives are intended to be included within the scope of the invention, as defined in the following claims. Those skilled in the art should also realize that such modifications and equivalent constructions or methods do not depart from the spirit and scope of the present disclosure, and that they may make various changes, substitutions, and alternations herein without departing from the spirit and scope of the present disclosure.

What is claimed is:

1. A claim recovery system, comprising:
an input engine configured to receive and copy a billing file having a claim record; and
a clearinghouse system and an accounts receivable management system each configured to receive a copy of the billing file from the input engine, and to cooperatively identify errors in the claim record and prevent erred claim records from progressing to a payor.

2. The system of claim 1, wherein the input engine is further configured to receive corrected claim records.

3. The system of claim 1, wherein the clearinghouse system further comprises a front-end processing engine configured to supplement claim data for each claim record with additional data useful in electronic invoicing.

4. The system of claim 1, wherein the clearinghouse system further comprises an error identification engine configured to identify errors in the claim record.

5. The system of claim 4, wherein the error identification engine is further configured to provide an activity report for the accounts receivable management system.

6. The system of claim 1, wherein the clearinghouse system further comprises an invoice assembly engine configured to assemble claim records for electronic invoicing.

7. The system of claim 1, wherein the clearinghouse system further comprises an invoice submission engine configured to submit claim records electronically to payors for payment.

8. The system of claim 1, wherein the accounts receivable management system is further configured to receive payment information regarding the claim record from the payor.

9. The system of claim 1, wherein the accounts receivable management system further comprises a claim activity record engine configured to establish and maintain an activity record for recovery efforts of each claim record.

10. The system of claim 9, wherein the claim activity record engine is further configured to receive an activity report regarding a first claim record for recordation in a first claim record activity record from any of the claim activity record engine, a correction engine, a front-end processing engine, an error identification engine, an invoice assembly engine, and an invoice submission engine.

11. The system of claim 1, wherein the accounts receivable management system further comprises a claim flagging engine configured to record process progression of each claim record.

12. The system of claim 1, wherein the accounts receivable management system further comprises a correction engine configured to perform correction action on erred claims.

13. The system of claim 1, wherein the accounts receivable management system further comprises a final disposition engine configured to assemble a final disposition of each claim record.

14. The system of claim 1, wherein the clearinghouse system further comprises:
a front-end processing engine configured to supplement data for each claim record with additional data useful in electronic invoicing;
an error identification engine configured to provide ongoing identification of errors in a claim record;
an invoice assembly engine configured to assemble claim records for electronic invoicing; and
an invoice submission engine configured to submit claim records for payment electronically.

15. The system of claim 14, wherein the error identification engine system is further configured to provide an activity report to the accounts receivable management system.

16. The system of claim 1, wherein the accounts receivable management system further comprises:
a claim activity record engine configured to establish and maintain an activity record for recovery efforts of each claim record;
a claim flagging engine configured to record process progression of each claim record;
a correction engine configured to perform correction action on erred claims; and
a final disposition engine configured to assemble a final disposition of each claim record.

17. The system of claim 1, wherein:
the input engine is further configured to receive corrected claim records;
the clearinghouse system further comprises:
a front-end processing engine configured to supplement data for each claim record with additional data useful in electronic invoicing;
an error identification engine configured to provide ongoing identification of errors in a claim record;
an invoice assembly engine configured to assemble claim records for electronic invoicing; and
an invoice submission engine configured to submit claim records for payment electronically; and the accounts receivable management system further comprises:
a claim activity record engine configured to establish and maintain an activity record for recovery efforts of each claim record;
a claim flagging engine configured to record process progression of each claim record;
a correction engine configured to perform correction action on erred claims; and
a final disposition engine configured to assemble a final disposition of each claim record.

18. The system of claim 17, wherein the error identification engine system is further configured to provide an activity report to the accounts receivable management system.

19. A claim recovery system, comprising:
an input engine configured to receive and copy a billing file having a claim record, and to receive corrected claim records;
a clearinghouse system configured to receive a first copy of the billing file from the input engine;
the clearinghouse system further comprising a front-end processing engine configured to supplement claim data for each claim record with additional data useful in electronic invoicing, an error identification engine configured to identify errors in the claim record and to provide an activity report to the accounts receivable management system, an invoice assembly engine configured to assemble the claim records for electronic invoicing, and an invoice submission engine configured to submit the claim records electronically to payors for payment; and
an accounts receivable management system configured to receive a second copy of the billing file from the input engine, and to cooperatively, with the clearinghouse system, identify errors in the claim record and prevent erred claim records from progressing to payors, and to receive payment information regarding the claim record from payors, the accounts receivable management system further comprising a claim activity record engine configured to establish and maintain an activity record for recovery efforts of each claim record, and to receive the activity report from any of the claim activity record engine, a correction engine, the front-end processing engine, the error identification engine, the invoice assembly engine, and the invoice submission engine, a claim flagging engine configured to record process progression of each claim record, the correction engine configured to perform correction action on erred claims, and a final disposition engine configured to assemble a final disposition of each claim record.

20. A method for increasing claim recovery efficiency, comprising:
conducting intake-processing on a billing file, having a claim record;
copying and distributing the billing file to both a clearinghouse system and an accounts receivable management system; and
processing the billing file concurrently in both the clearinghouse system and the accounts receivable management system to cooperatively identify errors in the claim record and prevent erred claim records from progressing to a payor.

21. The method of claim 20, wherein processing the billing file further comprises:
establishing and maintaining an activity record for each claim in the billing file;
documenting claim activity in the activity record in order to compile a record of activity taken to recover the claim;
conducting front-end processing on the billing file to supplement data for each claim record with additional data useful in electronic invoicing;
identifying errors in the billing file in order to direct an erred claim record for correction action;
taking error correction action on the erred claim record; and
assembling an invoice of the claim record not identified to have errors.

22. The method of claim 21, wherein processing the billing file further comprises:
flagging the claim record to record the respective claim record's process progression.

23. The method of claim 20, further comprising:
receiving non-payment information directly from the payor;
reviewing non-payment information for errors;
taking error correction action on the claim record associated with erred non-payment information; and
assembling and transmitting an invoice for the claim record associated with corrected non-payment information.

24. A method for increasing claim recovery efficiency, comprising:
conducting intake-processing on a billing file having a claim record;
copying and distributing the billing file to both a clearinghouse system and an accounts receivable management system;
establishing and maintaining an activity record for each claim in the billing file;
documenting claim activity in the activity record in order to compile a record of activity taken to recover the claim;
conducting front-end processing on the billing file to supplement data for each claim record with additional data useful in electronic invoicing;
identifying errors in the billing file in order to direct an erred claim record for correction action;
taking error correction action on the erred claim record; and
assembling an invoice of the claim record not identified to have errors.

25. The method of claim 24, further comprising:
flagging the claim record to record the respective claim record's process progression.

26. The method of claim 24, further comprising:
receiving non-payment information directly from a payor;
reviewing the non-payment information for errors;
taking error correction action on the claim record associated with erred non-payment information; and
assembling and transmitting an invoice for the claim record associated with corrected non-payment information.
